(19) United States
(12) Patent Application Publication
(10) Pub. No.: US 2016/0034454 A1
(43) Pub. Date: Feb. 4, 2016

(54) CROWDSOURCED PAIR-BASED MEDIA RECOMMENDATION

(71) Applicant: Luma, LLC, St. Louis Park, MN (US)

(72) Inventors: James Musil, Minneapolis, MN (US); Aaron Weber, Orono, MN (US); Colin Keeley, Minneapolis, MN (US); Robert Bodor, Plymouth, MN (US)

(21) Appl. No.: 14/879,469

(22) Filed: Oct. 9, 2015

Related U.S. Application Data
(63) Continuation-in-part of application No. 14/483,452, filed on Sep. 11, 2014.
Application No. 14/483,452 is a continuation-in-part of application No. 14/832,279, filed on Aug. 21, 2015.
Application No. 14/832,279 is a continuation-in-part of application No. 13/792,729, filed on Mar. 11, 2013, now abandoned.
Application No. 13/792,729 is a continuation-in-part of application No. 12/892,274, filed on Sep. 28, 2010, now Pat. No. 8,401,983.
Application No. 12/892,274 is a continuation-in-part of application No. 12/892,320, filed on Sep. 28, 2010, now Pat. No. 8,825,574.
Application No. 12/892,320 is a continuation-in-part of application No. 12/903,830, filed on Oct. 13, 2010.
(60) Provisional application No. 61/876,653, filed on Sep. 11, 2013.
(60) Provisional application No. 61/251,191, filed on Oct. 13, 2009.

(51) Int. Cl. G06F 17/30

(52) U.S. Cl. CPC G06F 17/30029; G06F 17/3005; G06F 17/30528

(57) ABSTRACT

A method of generating media pair similarity ratings comprises presenting a user with a first media item, and querying the user regarding additional media items that are most similar to the first media item. Input is received from the user indicating the additional media items that are most similar to the first media item; and a pair similarity rating is set for the first media item and at least one of the additional media items based at least in part on the input indicating the additional media items most similar to the first media item.

### CROSS-REFERENCE TO RELATED APPLICATIONS

This application is a continuation-in-part of U.S. patent application Ser. No. 14/483,452, filed on Sep. 11, 2014, which claims the benefit of U.S. Provisional Application No. 61/876,653, filed on Sep. 11, 2013. This application is also a continuation-in-part of U.S. patent application Ser. No. 14/832,279, filed on Aug. 21, 2015, which is a continuation-in-part of U.S. patent application Ser. No. 13/792,729, filed on Mar. 11, 2013, which is a continuation-in-part of U.S. patent application Ser. No. 12/892,274, now U.S. Pat. No. 8,401,983, filed on Sep. 28, 2010. The present application is further continuation-in-part of U.S. patent application Ser. No. 12/892,320, now U.S. Pat. No. 8,825,574, filed on Sep. 28, 2010. This application is further continuation-in-part of U.S. patent application Ser. No. 12/903,830, filed on Oct. 13, 2010, and which claims the priority of U.S. Provisional Application No. 61/251,191, filed on Oct. 13, 2009. All of the U.S. priority applications are herein incorporated by reference.

### FIELD

The invention relates generally to media item recommendation, and more specifically to crowdsourced pair-based media recommendation.

### BACKGROUND

The rapid growth of the Internet and the proliferation of inexpensive digital media devices have led to significant changes in the way media is bought and sold. Online vendors provide music, movies, and other media for sale on websites such as Amazon, for rent on websites such as Netflix, and available for person-to-person sale on websites such as EBay. The media is often distributed in a variety of formats, such as a movie available for purchase or rental on a DVD or Blu-Ray disc, for purchase and download, or for streaming delivery to a computer, media appliance, or mobile device.

Internet companies that provide media such as music, books, and movies derive profit from their sales, and it is in their best interest to sell customers multiple items or subscriptions to provide an ongoing stream of profits. Netflix, for example, provides a subscription service to customers enabling them to rent or stream movies, and profits as long as subscribers continue to find enough new movies to watch to remain a subscriber. Pandora provides streaming audio in a customized music station format based on a customer's music preferences, deriving profit from either subscriptions or from advertising placed in limited free services. Amazon derives the majority of its profits from sale of physical media, and increases its profit from providing a customer with media recommendations similar to items that a customer has already purchased.

Recommendations such as these are typically made by employing a recommendation engine to identify media that is similar to other media in which a customer has shown an interest, such as by purchasing, renting, or rating related media. Pandora, for example, uses an expert's characterization of a song using domain knowledge attributes such as structure, instrumentation, rhythm, and lyrical content to produce domain knowledge data for each song, and provides streaming songs matching identified customer preferences for one or more distinct customized stations based on its domain knowledge-based recommendation engine. Other media providers such as Netflix provide correlation-based recommendations, where user preferences for similar movies over a broad base of users and media are used to find preference correlation between the media and users in the database to recommend media correlated to other media a customer has liked.

Because the number of items purchased or the length of a subscription are related to the value customers receive in continuing to interact with a media provider, it is in the provider's best interest to provide media recommendations that are accurate and well-tailored to its customers, and that are usable in a variety of media use environments. Because the quality of media recommendations in many systems is related to the quality of the underlying media correlation data or domain knowledge data for the candidate media items that may be recommended, it is desirable to use high quality media data to provide the best quality media recommendations.

### SUMMARY

One example embodiment of the invention comprises a method of generating media pair similarity ratings by presenting a user with a first media item, and querying the user regarding additional media items that are most similar to the first media item. Input is received from the user indicating the additional media items that are most similar to the first media item; and a pair similarity rating is set for the first media item and at least one of the additional media items based at least in part on the input indicating the additional media items most similar to the first media item.

In a further example, the user is presented with two or more candidate media items, and an indication is received from the user which of two or more candidate media items is known to the user. The indicated candidate media item is used as first media item.

In another example embodiment, a method of generating media pair similarity ratings comprises presenting a user with a first media item for which the user has a rating in a media recommendation system. The user is queried regarding which of two or more additional media items are most similar to the first media item, and input is received from the user indicating which of the two or more additional items are most similar to the first media item. A pair similarity rating is set for the first media item and at least one of the two or more additional media items based at least in part on the input indicating which of the two or more additional media items are most similar to the first media item.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a crowdsourced pair-based media recommendation system, consistent with an example embodiment of the invention.

FIG. 2 shows a web page for crowdsource users to provide movie pair data, consistent with an example embodiment of the invention.

FIG. 3 shows a database comprising media pair similarity data, consistent with an example embodiment of the invention.

FIG. 4 is a flowchart of a method of gathering crowdsourced pair-based media similarity data, consistent with an example embodiment of the invention.

FIG. 5 is a computerized media recommendation system comprising a crowdsourced pair-based engine, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Recommendation of media such as books, movies, or music that a customer is likely to enjoy can improve the sales of online merchants such as Amazon, improve the subscription rate and customer duration of rental services such as Netflix, and help the utilization rate of advertising-driven services such as Pandora. Although revenue is derived from providing media in different ways in each of these examples, they all benefit from providing good quality recommendations to customers regarding potential media purchases, rentals, or other media use. Similarly, knowledge of a user's preferences and interests can help target advertising that is relevant to a particular user, such as advertising horror movies only to those who have shown an interest in honor films, targeting country music advertising toward those who prefer country to rap or pop music, and presenting advertising for a new book to those who have shown a preference for similar books.

Media recommendations such as these are typically made by employing a recommendation engine to identify media that is similar to other media in which a customer has shown an interest, such as by purchasing, renting, or rating other similar media. Some websites, such as Netflix, ask a user to rate dozens of movies upon enrollment so that the recommendation engine can provide meaningful results. Other websites such as Amazon rely more upon a customer's purchase history and items viewed during shopping. Pandora differs from these approaches in that a user can rate relatively few pieces of media, and is provided a broad range of potentially similar media based on domain knowledge of the selected media items.

Because the number of items purchased or the length of a subscription are related to the value a customer receives in interacting with a media provider, it is in the provider's best interest to provide media recommendations that are accurate and well-suited to its customers. Poor recommendations may result in a user abandoning a service or merchant for another, while good recommendations will likely result in additional sales and profit. It is therefore desirable to accurately characterize and predict a user's media preferences to provide the best quality media recommendations possible.

Making accurate recommendations relies in part in having accurate data regarding characteristics of media that may be recommended, so that information regarding a user's preferences can be used to accurately search through media to select items to recommend. For example, a system such as Pandora that relies on domain knowledge of songs to recommend other songs relies on accurate expert characterization of various attributes of each song in its library to enable songs to be found and recommended based on the characterized attributes. Other recommendation systems rely more heavily on correlation, such as determining what other items a user who likes a certain movie is most likely to like by mining a database of user ratings or preference information.

But, using correlation in media preference is an imperfect way of establishing similarity between items, as users may like unrelated items or otherwise rate different items similarly. For example, if a high percentage of users who like the movie The Notebook also like the movie Titanic, most people will agree that these movies have similar characteristics and appeal. If a high percentage of users who like the movie The Notebook also like the television show Mythbusters, the connection is less clear and there may be some question as to whether the correlation is due to an obscure or infrequently rated item having a chance correlation with other media.

Some embodiments of the invention therefore employ a crowdsourced pair-based media recommendation system that employs crowdsourced input regarding the similarity between various pairs of media items such as movies in the recommendation system's media database. In other embodiments, crowdsourced pair-based recommendations are similarly made for other products or services, such as restaurants, consumer goods, and the like.

In a more detailed example, several crowdsource users are each employed to provide pair-based feedback on media pairs, including in some embodiments having different users rate the same media pairs. Input from the users regarding the similarity of various media pairs is compiled, and a media recommendation system generates media recommendations based on a user's known media preferences and the compiled crowdsourced media pair data.

The crowdsource users who provide pair-based feedback on media pairs are not the same users seeking media recommendations in some embodiments, and in a further example are paid crowdsource workers who are compensated for their work in providing pair-based media input. Compensation may be based on the quality of user input, such as paying users who rate obscure or difficult pairs more than other users, or paying users who do not provide quality input less.

In one example, a crowdsource pair-based server presents a user with a first media item, such as a movie. The server then queries the user regarding additional media items that are most similar to the first media item. The user types in the names of similar media items in one such example, or picks the most similar media item from a group of additional media items in another example. The user can indicate they don't know the movie presented, and request another first media item if necessary. The user's input is saved, and used to set a pair similarity rating or score between the first media item and the additional media item or items indicated to be most similar to the first media item.

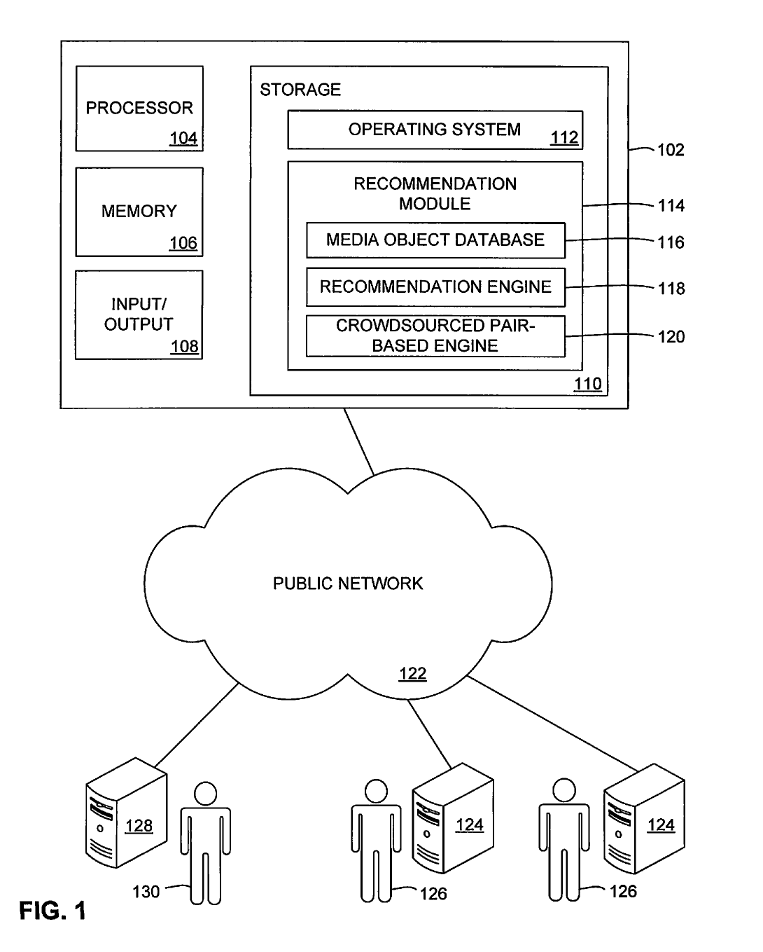

FIG. 1 shows a crowdsourced pair-based media recommendation system, consistent with an example embodiment of the invention. Here, media recommendation system 102 comprises a processor 104, memory 106, input/output elements 108, and storage 110. Storage 110 includes an operating system 112, and a recommendation module 114 that is operable to provide media item recommendations to a user, including media recommendations based on crowdsourced pair-based media pair information. The recommendation module 114 further comprises a media object database 116 operable to store media object information and user preference information for various media objects, and crowdsourced pair-based ratings based in data received from crowdsource users. A recommendation engine 118 is operable to use the stored media preference information for various recommendation system users to provide media recommendations. Crowdsourced pair-based engine 120 is operable to prompt crowdsource users for input regarding similarity between pairs of media items, and to use the input to derive media pair ratings or other media similarity information for use in media recommendation.

The media recommendation system 102 is connected to a public network 122, such as the Internet. Public network 122 serves to connect the media recommendation system media recommendation system 102 to remote computer systems, including crowdsource user computer 124 (associated with user 126), and media recommendation user computer 128 (associated with user 130).

In operation, the media recommendation system's processor 104 executes program instructions loaded from storage 110 into memory 106, such as operating system 112 and recommendation module 114. The recommendation module includes software executable to provide media recommendations to users such as user 130, using recommendation engine 118 and media object database 116.

The media item recommendations generated by recommendation engine 118 are based in some examples upon media preference information for a user, such as information regarding a user's media purchases, ratings, and viewings, across multiple websites and services. To produce the most accurate media recommendations, media recommendation system 102 gathers such media preference information to populate a media object database 116 containing each user's preferences. This information can then be used to generate recommendations for other media items, such as by using correlation-based recommendations, domain knowledge-based recommendations, or recommendations made using a combination of correlation-based and domain knowledge-based information.

In some examples, the recommendations provided to users 130 are derived at least in part from similarity between various media items in media object database 116, such as crowdsourced pair-based media information from crowdsource users 126 indicating the crowd's opinion regarding the similarity between various pairs of media items. This pair-based information or correlation information between pairs of media items is used along with information regarding the user's known preferences regarding certain media items to estimate the preference of the user for other media items, and to make media item recommendations.

In a more detailed example, the media recommendation system 102 has users that fill two different roles, including crowdsource users 126 and recommendation users 130. The crowdsource users 126 and recommendation users 130 may be the same users in some examples, fulfilling different roles in the media recommendation system. In other examples, crowdsource users 126 and matching users 130 will use different servers or computerized systems 102, configured to perform different functions.

Referring to FIG. 1, the matching users 130 use computers 128 to connect to the media recommendation server 102 to obtain media recommendations, such as recommendations of movies, television shows, and other media to watch based on media preferences for each user stored in the server and information known about the available media objects stored in media object database 116. This media object information includes similarity between various pairs of media items, such that a user's known preference for one or more media items can be used to predict preference for another media item.

The similarity between media objects is established at least in part by querying crowdsource users 126 regarding the similarity between various pairs of media objects using crowdsourced pair-based engine 120. The crowdsource users 126 use computers 124 via a network such as the Internet 122 to connect to a server executing the crowdsourced pair-based engine 120, which provides web pages or another suitable interface to query crowdsource users 126 regarding media item pair similarity.

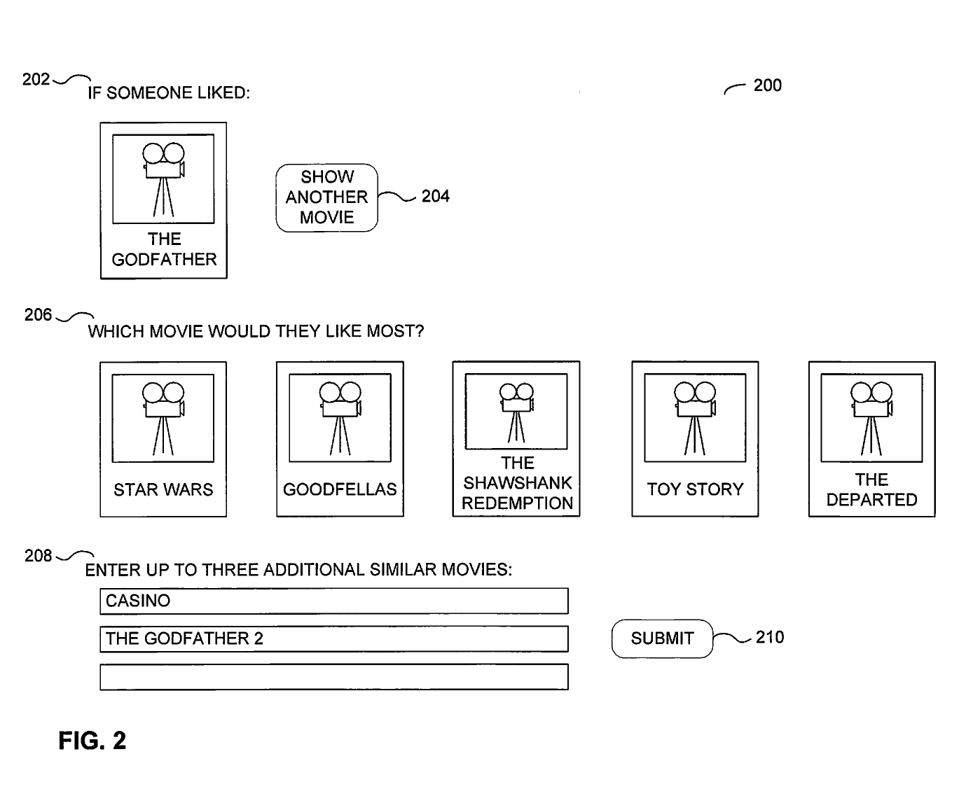

FIG. 2 shows a web page for crowdsource users to provide movie pair data, consistent with an example embodiment of the invention. The example web page shown may be presented to a crowdsource user such as user 130 of FIG. 1 using crowdsource user 130's computer 128 via a network connection to media server 102, which executes crowdsourced pair-based engine 120.

Here, a screen image shown generally at 200 includes a first media item, identified at 202. The first media item in this example is the movie The Godfather, and the crowdsource user is prompted to indicate what other movies someone who liked The Godfather would also like. If the crowdsource user is not familiar with the movie The Godfather, the user can click a “Show Another Movie” button at 204 to be presented with another first movie. In alternate embodiments, the crowdsource user picks a movie that the user is familiar with from a list of two or more movies.

In this example, the crowdsource user is prompted at 206 to indicate which of five additional movies someone who liked The Godfather would also enjoy, and in various embodiments the user selects one or multiple similar movies. In other examples, the user is presented with two additional movies, and picks the one that someone who liked The Godfather would most enjoy. This input signifies that a user believes the movie selected from the additional movies shown at 206 would be enjoyed most by someone who liked The Godfather, is counted as a positive vote for the pair of movies consisting of The Godfather and the selected movie, and a negative vote for the pair or pairs of movies consisting of The Godfather and the non-selected movies.

The input received from many crowdsource users for many different movie pairs is compiled over time, and the resulting movie pair data is used to determine which movies are most similar to one another to facilitate movie recommendations. For example, the crowdsource user of the web page shown at 200 may select Goodfellas as the movie that would be most liked by someone who likes The Godfather, and the indication would count as a positive vote for similarity between Goodfellas and The Godfather, and as a negative vote for similarity between The Godfather and the other four movies shown in the additional movies at 206.

In another example, the crowdsource user is prompted to enter up to three additional movies that are similar to The Godfather as shown at 208. The crowdsource user in this example has entered the movies Casino and The Godfather 2 as movies that are similar to The Godfather, and actuates the “Submit” button as shown at 210 after completing typing the additional similar movies.

In a more detailed example, the crowdsource users are presented with different stages or types of pair-based queries. For example, new movies for which there is no preliminary pair matching data may prompt crowdsource users only to type similar movies as shown at 208, and not prompt them to pick a most similar movie as shown at 206. Once a sufficient number of crowdsource users have been queried to determine approximate pair ratings between the new movie and several other movies, this data can be used with existing pair data for other movies to present crowdsource users with a second pair matching stage.

In one example second stage, a first movie is presented as shown at 202, and two additional movies are presented as shown at 206. The crowdsource user is prompted to pick which of the two additional movies are most similar to the first movie, and the user's input increases the pair match score between the first movie and the selected movie and decreases the pair match score between the first movie and the non-selected movie. In an alternate embodiment, the pair scores are adjusted to move the selected movie's pair score with the first movie toward being higher than the non-selected movie's pair score with the first movie, but specific pair scores may go up or down, or remain unchanged depending on how closely the current pair scores already accurately reflect this relationship.

Movies presented for pair matching at 206 are in some examples selected to have a threshold minimum current pair score with the first movie as shown at 202, such that the movies presented have at least some similarity. This avoids having a crowdsource user choose between two poor matches, such as choosing between two Disney movies as a match to The Godfather.

Quality of crowdsource user input is monitored in some examples by inserting test or trap questions with predetermined correct answers, such that if a crowdsource user just clicks the left-most of the movies presented at 206 repeatedly to rate high numbers of movies without regard to which movie is the best match, the user will eventually fail to answer a trap question correctly. For example, a user presented with Goodfellas and Star Wars at 206 as matches for The Godfather can be expected to pick Goodfellas as the best match, and selection of Star Wars can be interpreted as an indication that the user's input may be unreliable. The user's input for that session may therefore be discarded, and any compensation for rating movies may be withheld. Repeated failing of trap questions may result in a crowdsource user's entire set of input being discarded, and the crowdsource user may be blocked from providing further pair matching input.

In other examples, users providing pair matching input having poor correlation relative to other user input in matching the same or similar pairs of movies is used to identify users who are not providing meaningful or accurate input. Although occasional differences of opinion are likely to occur and contribute to the robustness of the pair-based data set, it is useful to distinguish crowdsource users providing random or incorrect input from those providing meaningful input, so that random or intentionally incorrect input can be discarded.

Crowdsource users in some examples are paid for their input, such as being paid a fixed amount per pair selected as at 206, or being paid a fixed amount per typed movie as shown at 208. Payment in a further example is dependent at least in part on the difficulty or time of the task performed, such as paying a user who types a movie at 208 three cents per typed movie, and paying a user who simply clicks a best match at 206 one cent per selected pair. In other examples, users who rate more obscure or more difficult movies are paid more for the expertise or knowledge needed to rate the movies.

When new movies are introduced, the number of crowdsource users familiar with the movie may be quite sparse. This is particularly true if a movie is unreleased, has been released overseas first, or is not a mainstream movie. Crowdsource users in instances such as these are paid to watch a trailer, or to otherwise become familiar with the movie in some embodiments to ensure that an accurate initial set of movie pair data for the new movie can be established.

The number of movie pairs needed to relate a movie to other movies in a large movie database is in some examples limited to only tens or hundreds of other movies, rather than the tens of thousands or more movies in the database. By using typed input as shown at 208, the crowdsourced pair-based engine 120 can quickly focus on the types of movies that are similar to a new movie, such as showing primarily movies similar to Goodfellas or The Departed once they have been provided as typed entries that are similar to The Godfather. Movies that are more similar to Toy Story or Star Wars than to Goodfellas or The Departed are likely poor matches for The Godfather, and so can be included sparsely or omitted from pair matching queries presented to crowdsource users.

This illustrates how similarity between movie pairs for existing movies can be used to select movies that are likely to be similar to a new movie, either for additional crowdsource user pair input or for recommendation. The process of determining movies similar to a new movie in crowdsource pair matching can be expedited by prompting crowdsource users to type names of similar movies as shown at 208 rather than discovering an initial group of similar media by trial and error using most similar selection process as shown at 206. Once initial similarity data is received for a new movie, this data can be used to select more appropriate candidates for similarity matching as shown at 206, or can be used to provide media recommendations to users such as 126.

Although the examples presented here reflect similarity ratings for movies, similar methods can be used for other media such as television, music, and the like. Further, media need not be restricted to media of the same type—a user that likes the movie Star Wars may well like the television show Star Trek, for example, and pair ratings for cross-type media pairs such as this can be used to provide such cross-media recommendations. In still further examples, the pair ratings include at least one non-media item, such as restaurants, hotels, or other goods or services.

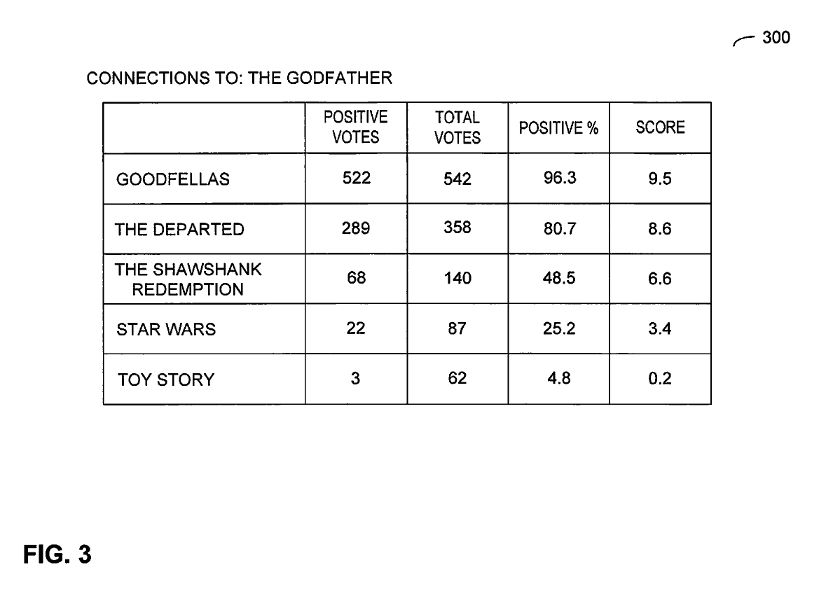

FIG. 3 shows a database comprising media pair similarity data, consistent with an example embodiment of the invention. Here, the database reflects the same five movies shown in FIG. 2, and data obtained through crowdsourced pair-based similarity data collection relating these five movies to The Godfather. In more typical implementations, the database would contain thousands of movies and in some embodiments other media.

In this example, the movie The Godfather was presented to many crowdsource users as a first movie, along with two additional movies as shown at 206 of FIG. 2. The crowdsource user was prompted to pick the movie more similar to The Godfather from the two additional movies, and the results were compiled in a media object database such as 116 of FIG. 1. The pair similarity data for each of these five movies relative to The Godfather is shown generally at 300.

Here, the movie Goodfellas was rated as the most similar movie 522 out of 542 times, or 96.3% of the time. This high positive vote percentage and top rating among the five movies listed here reflects that Goodfellas is likely the movie that would most be enjoyed by someone who enjoyed The Godfather. In contrast, the movie Toy Story was rated as the movie that someone who likes The Godfather would most enjoy a total of three times out of 62 appearances, or 4.8 percent of the time.

The chart further reflects that the movie Goodfellas was shown as one of two additional movies from which a crowdsource user chooses the movie that someone who likes The Godfather would most enjoy a total of 542 times, while the movie Toy Story was shown only 62 times. This reflects a preference for presentation of movies for which a higher percentage similarity is anticipated, such as movies typed by a crowdsource user at 208 or that have been frequently chosen by other crowdsource users at 202. This ensures that crowdsource users spend most of their time distinguishing between movies that are relatively similar to the first movie presented at 202.

The similarity rating is shown as a “Positive %” in FIG. 3, but in other embodiments will take other forms. For example, the “Score” column in FIG. 3 represents a normalized score based on the positive percent calculated in the neighboring column, including additional factors such as correlation in matching user preference for movies, third-party information sources, and the like. The similarity score in a further example is normalized, such as to cover a distribution so that all movies have high and low matches.

In some further embodiments, match percentages for a pair of media items are not the same, but instead depend on which media item is the first media item and which media item is the indicated similar media item. This enables first media items with relatively few similar media items to still have at least some media items rated as similar when it is selected as the first media item, but does not require that the similar item be rated as very similar to the first media item.

Initial pair similarity data is in the example above obtained through prompting crowdsource users to type names of media items similar to a first media item, but in other embodiments such data is obtained from other sources. For example, the first item may be located using a service such as Flixster, and media items indicated under “More Like This” may be used as similarity pair candidates. In another example, the first item may be located using a merchant such as Amazon, and items listed as “Frequently Bought Together” or “What Other Items Do Customers Buy After Viewing This Item” may be used as similarity pair candidates for the first media item.

In another example, media item characteristics are not explicitly listed and ranked as in domain knowledge-based systems such as Pandora, but movies are paired as having a similar desirability to users by the users themselves. The user has selected the movie Die Hard in this example and has already rated the movie, and so the user is prompted to indicate which of a list of potentially similar movies the user would or would not recommend to someone who liked Die Hard. The user in this example is further prompted to indicate whether certain less well-known movies are similar to Die Hard at 203, enabling the recommendation system to determine that similar movies such as Shoot to Kill should be moved to the user recommendation list at 202 while relatively unrelated movies such as Groundhog Day should potentially be excluded from further recommendation.

If a movie doesn't have a similarity pair ranking with another movie, a “rough” or estimated ranking is also determined in some embodiments using the information that is available, such as known similarity rankings between a third movie and each of the movies in the pair or by using media item meta-data such as genre.

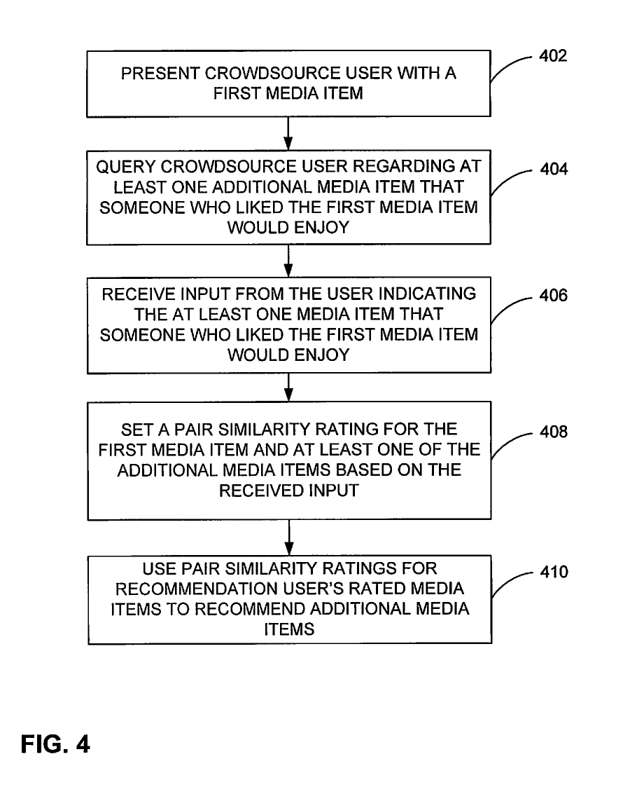

FIG. 4 is a flowchart of a method of gathering crowdsourced pair-based media similarity data, consistent with an example embodiment of the invention. A server presents a crowdsource user with a first media item at 402, such as via a web page or other suitable mechanism. The web page in this example queries the crowdsource user at 404 regarding at least one additional media item that someone who liked the first media item might enjoy.

The server receives input from the user at 406, indicating the at least one media item that someone who liked the first media item would enjoy. The input comprises in various embodiments typed input, selection from a list, clicking on one or more icons from a presentation of additional media item choices, or another suitable input. In a more detailed example, two additional media items are displayed, such as through icons or text representing the additional media items, and the crowdsource user is prompted to select the additional media item that someone who enjoyed the first media item would most enjoy.

In this example, asking what additional media item someone who enjoyed a first media item would most enjoy prompts the crowdsource user to indicate a kind of similarity that is in some media item recommendation applications more useful than simply asking the user what media item is the most similar, in that a user's enjoyment is more important than media similarities in title, actors, theme, or other such characteristics.

The server uses the similarity data to set a pair similarity rating for the first media item and at least one of the additional media items at 408, such as by storing the choice in a database or by altering a media pair rating in a database. A media recommendation engine then uses the pair similarity ratings to recommend media items to a recommendation user at 410, by recommending media items that have a high similarity rating to movies the recommendation user has previously rated highly or that the recommendation user has provided other indication of enjoyment.

The crowdsource server and recommendation server in the examples presented here comprise parts of the same server, but in other embodiments will be separate servers, distributed servers, or otherwise configured differently to provide the various functions described herein.

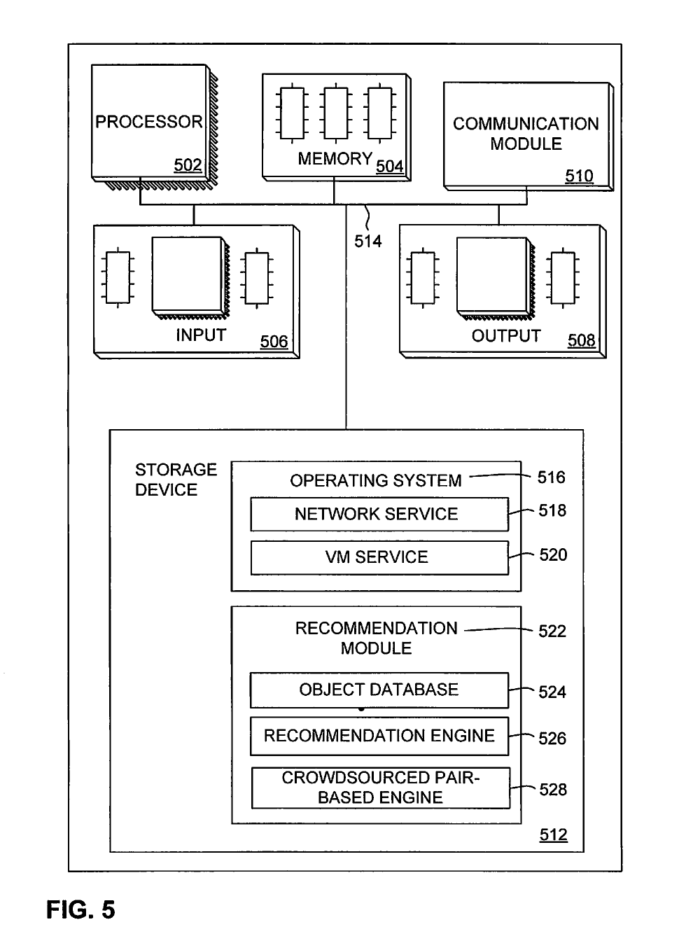

FIG. 5 is a computerized media recommendation system comprising a crowdsourced pair-based engine, consistent with an example embodiment of the invention. FIG. 5 illustrates only one particular example of computing device 500, and other computing devices 500 may be used in other embodiments. Although computing device 500 is shown as a standalone computing device, computing device 500 may be any component or system that includes one or more processors or another suitable computing environment for executing software instructions in other examples, and need not include one or more of the elements shown here.

As shown in the specific example of FIG. 5, computing device 500 includes one or more processors 502, memory 504, one or more input devices 506, one or more output devices 508, one or more communication modules 510, and one or more storage devices 512. Computing device 500, in one example, further includes an operating system 516 executable by computing device 500. The operating system includes in various examples services such as a network service 518 and a virtual machine service 520 such as a virtual server. One or more applications, such as recommendation module 522 are also stored on storage device 512, and are executable by computing device 500. Each of components 502, 504, 506, 508, 510, and 512 may be interconnected (physically, communicatively, and/or operatively) for inter-component communications, such as via one or more communications channels 514. In some examples, communication channels 514 include a system bus, network connection, inter-processor communication network, or any other channel for communicating data. Applications such as recommendation module 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 504. Examples of processors 502 include any one or more of a microprocessor, a controller, a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, known as a computer-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as recommendation module 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 510 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communication s (NFC), and Universal Serial Bus (USB). In some examples, computing device 500 uses communication module 510 to wirelessly communicate with an external device such as via public network 122 of FIG. 1.

Computing device 500 also includes in one example one or more input devices 506. Input device 506, in some examples, is configured to receive input from a user through tactile, audio, or video input. Examples of input device 506 include a touchscreen display, a mouse, a keyboard, a voice responsive system, video camera, microphone or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 508 include a speaker, a light-emitting diode (LED) display, a liquid crystal display (LCD), or any other type of device that can generate output to a user.

Computing device 500 may include operating system 516. Operating system 516, in some examples, controls the operation of components of computing device 500, and provides an interface from various applications such as recommendation module 522 to components of computing device 500. For example, operating system 516, in one example, facilitates the communication of various applications such as recommendation module 522 with processors 502, communication unit 510, storage device 512, input device 506, and output device 508. Applications such as recommendation module 522 may include program instructions and/or data that are executable by computing device 500. As one example, recommendation module 522 and its object database 524, recommendation engine 526, and crowdsourced pair-based engine 528 may include instructions that cause computing device 500 to perform one or more of the operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of generating media pair similarity ratings, comprising:
presenting a user with a first media item;
querying the user regarding one or more additional media items that are most similar to the first media item;
receiving input from the user indicating the one or more additional media items that are most similar to the first media item; and
setting a pair similarity rating for the first media item and at least one of the one or more additional media items based at least in part on the input indicating the one or more additional media items most similar to the first media item.

2. The method of generating media pair similarity ratings of claim 1, further comprising:
presenting the user with at least one candidate media item;
receiving an indication from the user that the at least one candidate media item is known to the user; and
using the indicated candidate media item as first media item.

3. The method of generating media pair similarity ratings of claim 2, further comprising:
receiving an indication that the user does not know any of the at least one candidate media items; and
presenting the user with at least one additional candidate media item.

4. The method of generating media pair similarity ratings of claim 1, wherein the input indicating the additional media items that are most similar to the first media item comprises typed user entry of a similar media item name.

5. The method of generating media pair similarity ratings of claim 1, wherein the input indicating the additional media items that are most similar to the first media item comprises user selection from a presentation of two or more additional media items.

6. The method of generating media pair similarity ratings of claim 1, wherein the input indicating the additional media items that are most similar to the first media item comprises one or more additional media items of a different type than the first media item.

7. The method of generating media pair similarity ratings of claim 6, wherein types of media items include movies, television, music, websites, apps, magazines, newspapers, radio stations, sports, and blogs.

8. The method of generating media pair similarity ratings of claim 1, wherein users comprise media recommendation system users.

9. The method of generating media pair similarity ratings of claim 8, wherein the first media item comprises a media item for which the user has a rating or other indication of familiarity.

10. The method of generating media pair similarity ratings of claim 1, wherein the first media item comprises a trap media item with a predetermined anticipated input from the user indicating the additional media items that are most similar to the first media item, such that the user's input for one or more other first media items is disregarded if an input other than the predetermined anticipated input is received from the user.

11. The method of generating media pair similarity ratings of claim 1, wherein the user is paid to provide the input indicating the additional media items that are most similar to the first media item.

12. The method of generating media pair similarity ratings of claim 11, further comprising pay users who provide good data more than users who provide bad data, wherein the determination of whether the user's input indicating the additional media items that are most similar to the first media item is good data or bad data is based at least in part on correlation with input from other users or on trap first media items.

13. The method of generating media pair similarity ratings of claim 11, wherein the user is paid more for more difficult first media items.

14. The method of generating media pair similarity ratings of claim 11, further comprising paying the user to familiarize themselves with a new or unknown media item as the first media item.

15. The method of generating media pair similarity ratings of claim 1, further comprising disregarding input from users who provide bad data, wherein the determination of whether the user's input indicating the additional media items that are most similar to the first media item is bad data is based at least in part on poor correlation with input from other users or on incorrect input in response to trap first media items.

16. The method of generating media pair similarity ratings of claim 1, further comprising using the similarity rating between first media item and at least one of the additional media items to provide a user media recommendation for one or more media items.

17. A media pair similarity rating system, comprising:
a processor; and
a media pair similarity rating module comprising instructions executable on the processor that are operable when executed to:
present a user with a first media item;
query the user regarding one or more additional media items that are most similar to the first media item;
receive input from the user indicating the one or more additional media items that are most similar to the first media item; and
set a pair similarity rating for the first media item and at least one of the one or more additional media items based at least in part on the input indicating the one or more additional media items most similar to the first media item.

18. The media pair similarity rating system of claim 17, wherein receiving input from the user indicating the one or more additional media items that are most similar to the first media item comprises user selection from a presentation of two or more additional media items.

19. A method of generating media pair similarity ratings, comprising:
presenting a user with a first media item for which the user has a rating in a media recommendation system;
querying the user regarding which of two or more additional media items are most similar to the first media item;
receiving input from the user indicating which of the two or more additional items are most similar to the first media item; and
setting a pair similarity rating for the first media item and at least one of the two or more additional media items based at least in part on the input indicating which of the two or more additional media items are most similar to the first media item.

20. The method of generating media pair similarity ratings of claim 19, wherein setting a pair similarity rating for the first media item and at least one of the two or more additional media items comprises setting a pair similarity rating for the first media item and the additional media item indicated most similar to the first media item.
